(19) United States
(12) Patent Application Publication
(10) Pub. No.: US 2010/0171235 A1
(43) Pub. Date: Jul. 8, 2010

(54) RESIN COMPOSITION FOR POROUS-MATERIAL PROCESSING AND PROCESS FOR PRODUCING FORMED POROUS MATERIAL

(75) Inventors: Masanori Ogawa, Aichi (JP); Makoto Fujii, Aichi (JP); Naohiro Mizutani, Aichi (JP)

Correspondence Address: COOPER & DUNHAM, LLP, 30 Rockefeller Plaza, 20th Floor, NEW YORK, NY, 10112, US

(73) Assignee: NAGOYA OILCHEMICAL CO., LTD., Tokai-shi, Aichi (JP)

(21) Appl. No.: 12/601,428

(22) PCT Filed: Feb. 13, 2008
(86) PCT No.: PCT/JP2008/052330

§ 371 Date: Nov. 23, 2009

(30) Foreign Application Priority Data
May 24, 2007 (JP) 2007-138346

(51) Int. Cl. B29C 70/40; B29C 67/20

(52) U.S. Cl. 264/136; 264/134

(57) ABSTRACT

An object of the present invention is to prevent the occurrence of resinous gloss on the surface of a molded porous material into which a synthetic resin is impregnated, and to attain this object, the present invention provides a resin compound for processing a porous material by coating, impregnating or mixing it on/in to the porous material wherein a colloidal silica is added to a thermosetting resin in an amount of more than 5% by mass, so that when the porous material which is processed by the resin compound is press molded, and as the resin compound oozes to the surface of the resulting molded porous material, the colloidal silica prevents the occurrence of the resinous gloss on the surface of the molded porous material.

### FIELD OF THE INVENTION

The present invention relates to a resin compound used as a molded porous material for automobile or building interiors or exteriors, and further relates to a method for the manufacturing of a molded porous material processed by said resin compound.

### BACKGROUND OF THE INVENTION

Hitherto, said molded porous material has been used for automobile or building interiors or exteriors, said porous material being such as a fiber sheet or the like, which is usable as a surface material or base material. To manufacture said molded porous material, a powder type or water solution type thermosetting resin, or the like, is coated or impregnated on/in to said porous material, after which said porous material is then hot pressed into a prescribed shape.

### DISCLOSURE OF THE INVENTION

### The Problems to be Solved by the Invention

The porous material used in said traditional molded porous material has an almost uniform thickness at a first glance, however, upon closer inspection, the thickness of said porous material has a slight unevenness, caused by the partial unevenness of its unit weight, molded shape, or the like. It is very difficult to resolve and prevent said slight inconsistencies in thickness caused by partial unevenness of its unit weight, molded shape, or the like. Due to said slight, partial unevenness of thickness, the amount of resin coating used, and the partial unevenness of the face pressure affecting the surface of said porous material while being molded, or the like, the thermosetting resin impregnated into said porous material may partially oozes to its surface when hot pressed. Said thermosetting resin oozing to the surface of said porous material causes small dotted resinous gloss partially on the surface of the resulting molded porous material.

Recently the appearance of the surface of said molded porous material has been also important from the aspect of a sense of high quality of an automobile and the like, and small glossy resinous dots on the surface of a big-ticket item like an automobile are problematic in that they appear as a product defect.

It is considered that the cause of said resinous gloss occurrence is that said thermosetting resin binds to the surface of the fiber sheet as small particles, without forming a continuous film. In other words, said thermosetting resin is cured through a melting-curing process when said porous material is hot-pressed, and said thermosetting resin oozing to its surface of said porous material in small particles is crushed to cure due to the pressure of the press, resulting in small dotted resinous gloss occurring on the surface of the resulting molded porous material.

### Means to Solve the Problems

The object of the present invention is to solve said conventional problem, and prevent the occurrence of the resinous gloss on the surface of said molded porous material, and the present invention provides a resin compound for processing a porous material by coating, impregnating or mixing said resin compound on/in to said porous material, wherein a colloidal silica is mixed into a thermosetting resin in an amount of more than 5% by mass, and further provide a method for manufacturing a molded porous material comprising: coating, impregnating or mixing said resin compound on/in to a porous material, and press-molding said porous material on/in to which said resin compound is coated or impregnated or mixed. Generally said porous material is a fiber sheet.

### Effect of the Invention

[Action]

A colloidal silica is mixed into a thermosetting resin for processing a porous material in an amount of more than 5% by mass, following which the resulting resin compound is then coated, impregnated or mixed on/in to said porous material. When the resulting porous material on/in to which said thermosetting resin is coated, impregnated or mixed is press-molded, said thermosetting resin oozes to the surface of said porous material due to the pressure of the press, but since colloidal silica having small particle size binds to the surface of said thermosetting resin, the occurrence of resinous gloss on the surface of said molded porous material is prevented by the mat effect of said colloidal silica.

[Effect]

Accordingly, in the present invention, even if said thermosetting resin oozes to the surface of said porous material due to the pressure of the press, a preferable looking molded porous material without resinous gloss on its surface can be obtained.

### Best Mode to Practice the Invention

The present invention is described in detail below.

[Porous Material]

A fiber sheet is generally used as a porous material in the present invention, and said fiber sheet is generally made of a fiber, for example, a vegetable fiber such as kenaf fiber, hemp fiber, palm fiber, bamboo fiber, abaca fiber, and the like, a synthetic resin fiber such as polyester fiber, polyamide fiber, acrylic fiber, urethane fiber, polyvinyl chloride fiber, polyvinylidene chloride fiber, acetate fiber, and the like, a natural fiber such as wool, mohair, cashmere, camel hair, alpaca, vicuna, angora, silk, and the like, a biologically decomposable fiber made of lactic acid produced from corn starch etc, a cellulose group artificial fiber such as rayon (artificial silk, viscose staple fiber), polynosic, cuprammonium rayon, acetate, triacetate, and the like, inorganic fiber such as glass fiber, carbon fiber, ceramic fiber, asbestos fiber, and the like, a reclaimed fiber produced by the opening of scrap fiber product made of said fiber(s). Said fiber is used singly or two or more kinds of said fiber may be used together as the material of said fiber sheet.

Further said fiber sheet may partially or wholly use a thermoplastic resin fiber having a low melting point below 180° C. like a polyolefin group fiber such as polyethylene, polypropylene, ethylene-vinyl acetate copolymer, ethylene-ethyl acrylate copolymer, and the like, polyvinyl chloride fiber, polyurethane fiber, polyester fiber, copolymerized polyester fiber, polyamide fiber, copolymerized polyamide fiber, and the like. With the exception of said fiber sheet, a foamed plastic such as polystyrene foam, polyethylene foam, polypropylene foam, polyurethane foam and the like, are also usable as a porous material for the present invention.

Said fiber sheet is prepared by a process wherein the web sheet or mat of said fiber mixture is interwined by needle-punching, or a process of spunbonding, or a process wherein in a case where said web sheet or mat consists of or includes a fiber having a low melting point, said sheet or mat is heated to soften said low melting point fiber so as to be a binder, or a process wherein synthetic resin is impregnated or mixed into said sheet or mat as a binder, or a process wherein first said sheet or mat is interwined by needle punching, then heated to soften to be a binder, or a process wherein said synthetic resin binder is impregnated into said sheet or mat to bind the fibers in said sheet or mat, or a process wherein said fiber mixture is knitted or woven.

[Resin]

In order for a resin to be coated, or impregnated or mixed on/in to said porous material, a thermosetting resin such as a phenol group resin (PF), melamine resin (MF), urea resin (UF) and the like is used in the present invention. Further, a resin precursor such as urelamine resin prepolymer, urea resin prepolymer (precondensation polymer) phenol group resin prepolymer (precondensation polymer) and the like may be used instead of said thermosetting resin.

Said synthetic resin may be used singly, or two or more kinds of said synthetic resin may be used together, and said synthetic resin is generally provided as a powder, emulsion, latex, water solution, organic solvent solution, and the like.

A preferable synthetic resin used in the present invention is a phenol group rein. Said phenol group resin is of two types, one is resol produced by adding an excess amount of formaldehyde to a phenol group compound and reacting by using an alkaline catalyst, the other is novolak which is produced by adding an excess amount of phenol group compound to formaldehyde, and reacting by using an acid catalyst. Said resol consists of a mixture of many kinds of phenol alcohols wherein phenol and formaldehyde are added together, and said resol is generally provided as a water solution. Said novalac consists of many kinds of dihydroxydiphenylmethane group derivatives wherein phenol condenses further to phenol alcohol, and said novalac is generally provided as a powder.

In the present invention, the desirable phenolic resin is phenol-alkylresorcinol cocondensation polymer. Said phenol-alkylresorcinol cocondensation polymer provides a water solution of said cocondensation polymer (pre-cocondensation polymer) having good stability, and being advantageous in that it can be stored for a longer time at room temperature, compared with a condensate consisting of only a phenol (precondensation polymer). Further, in a case where said sheet material is impregnated or coated with said water solution, and then precured, said material has good stability and does not lose its moldability after long-term storage. Further, since alkylresorcinol is highly reactive to formaldehyde group compounds, and catches free aldehyde to react with, the content of free aldehyde in the resin can be reduced.

When said phenol group resin is produced, if necessary, a catalyst or pH conditioner may be added. Further in the precondensation polymer of phenol group resin of the present invention (including precocondensation polymer), a curing agent such as formaldehyde, alkylolated triazone derivative or the like may be mixed. Still further, in a case where a water soluble phenol group resin is used, said phenol group resin may be sulfomethylated and/or sulfimethylated to improve its stability.

Into said synthetic resin used in the present invention, further, an inorganic filler, such as calcium carbonate, magnesium carbonate, barium sulfate, calcium sulfate, calcium sulfite, calcium phosphate, calcium hydroxide, magnesium hydroxide, aluminium hydroxide, magnesium oxide, titanium oxide, iron oxide, zinc oxide, alumina, silica, diatomaceous earth, dolomite, gypsum, talc, clay, asbestos, mica, calcium silicate, bentonite, white carbon, carbon black, iron powder, aluminum powder, glass powder, stone powder, blast furnace slag, fly ash, cement, zirconia powder, or the like ; a natural rubber or its derivative ; a synthetic rubber such as styrene-butadiene rubber, acrylonitrile-butadiene rubber, chloroprene rubber, ethylene-propylene rubber, isoprene rubber, isoprene-isobutylene rubber, or the like; a water-soluble macromolecule and natural gum such as polyvinyl alcohol, sodium alginate, starch, starch derivative, glue, gelatin, powdered blood, methyl cellulose, carboxy methyl cellulose, hydroxy ethyl cellulose, polyacrylate, polyacrylamide, or the like; an organic filler such as, wood flour, walnut powder, coconut shell flour, wheat flour, rice flour, or the like; a higher fatty acid such as stearic acid, palmitic acid, or the like; a fatty alcohol such as palmityl alcohol, stearyl alcohol, or the like ; a fatty acid ester such as butyryl stearate, glycerin mono stearate, or the like; a fatty acid amide; natural wax or composition wax such as carnauba wax, or the like; a mold release agent such as paraffin, paraffin oil, silicone oil, silicone resin, fluorocarbon polymers, polyvinyl alcohol, grease, or the like; an organic blowing agent such as azodicarbonamide, N,N′-dinitrosopentamethylenetetramine, p,p′-oxybis(benzenesulfonylhydrazide), azobis-2,2′-(2-methylpropionitrile), or the like; an inorganic blowing agent such as sodium bicarbonate, potassium bicarbonate, ammonium bicarbonate or the like; hollow particles such as shirasu balloon, perlite, glass balloon, plastic foaming glass, hollow ceramics, or the like; foaming bodies or particles such as foaming polyethylene, foaming polystyrene, foaming polypropylene, or the like; a pigment; dye; antioxidant; antistatic agent; crystallizer; flameproof agent; water-repellent agent; oil-repellent agent; insecticide agent; preservative; wax; surfactant; lubricant; antioxidant; ultraviolet absorber; plasticizer such as phthalic ester (ex. dibutyl phthalate(DBP), dioctyl phthalate(DOP), dicyclohexyl phthalate) and others(ex. tricresyl phosphate), can be added or mixed.

[Colloidal Silica]

The colloidal silica used in the present invention is minute particle silica or alumina coated minute particle silica, and generally the average particle size of said colloidal silica is in the range of between 1 to 100 μm, preferably 3 to 50 μm. Said colloidal silica is generally provided as a dispersion in which said colloidal silica is dispersed in water. In a case where the average particle size of said minute particle silica is beyond 100 μm, it is feared that the resin oozing layer will become whitish, and in a case where the average particle size of said minute particle silica is under 1 μm, the surface area of said minute particle silica will expand excessively and negatively influence the stability of the dispersion.

[Preparation]

In said resin compound of the present invention, it is necessary to add said colloidal silica to said resin in an amount of more than 5% by mass as silicic acid anhydride (SiO₂). In a case where said colloidal silica is added to said resin in an amount of under 5% by mass, the occurrence of resinous surface gloss cannot be prevented. The desirable amount of said colloidal silica to be added to said resin is set to be 95:5 to 40:60 as the mass ratio of said resin: SiO₂.

[Impregnating, Coating or Mixing of Said Resin Compound]

To impregnate or coat said resin compound in/on to said porous material, said porous material is generally impregnated with a liquid resin, resin solution, or resin emulsion, or said liquid resin, resin solution or resin emulsion is coated onto said porous material using a knife coater, roll coater, flow coater, or the like, or in a case where said resin is a powder, said powdery resin is mixed into said porous material, after which said porous material into which said powdery resin is mixed is formed into a sheet. To adjust the amount of said resin compound in said porous material into which said resin compound is impregnated or mixed, after said resin compound is impregnated, coated or mixed in/on to said porous material, said porous material is squeezed using a squeezing roll, press machine, or the like.

In a case where said resin compound contains a phenol group resin, and if said phenol group resin is a powdery precondensation polymer, said powdery precondensation polymer is mixed into said porous material, and then said porous material is formed into a sheet, and if said precondensation polymer is dissolved in a water soluble organic solvent etc. to prepare an aqueous precondensation polymer solution, said solution is impregnated or coated in/on to said porous material. After said resin compound is impregnated or coated or mixed in/on to said porous material, said porous material in/on to which said resin compound is impregnated, coated or mixed is dried desirably by heating.

Further, a powdery solid flame retardant such as an expandable graphite may be added to said porous material. To add said powdery solid flame retardant to said porous material, after said resin compound is impregnated into said porous material, a dispersion, wherein said powdery solid flame retardant is dispersed into said resin compound solution or emulsion, water solution of a water soluble resin, or emulsion of alkali soluble resin, is prepared, and said dispersion is then coated or impregnated on/in to said porous material.

[Molding Said Porous Material]

Said porous material of the present invention is molded into a panel shape or prescribed shape, generally by hot-press molding, and in a case where a thermosetting resin is impregnated into said porous material, said hot-press molding is carried out at a temperature over the hardening start temperature of said thermosetting resin, and in a case where said expandable graphite is added to said porous material, said hot press-molding is carried out at a temperature below the expansion start temperature of said expandable graphite.

Said porous material of the present invention may be hot-pressed into a prescribed shape after said fiber sheet is hot-pressed into a flat panel, and further, in a case where low melting point fibers, or a thermoplastic resin is contained in said fiber sheet, said fiber sheet may be heated so as to soften said low melting point fibers or said thermoplastic resin, after which said fiber sheet may be cold-pressed into a prescribed shape. As described above, however, if said porous material of the present invention is a fiber sheet, since said fiber sheet contains other fibers, especially low melting point fibers, in an amount of less than 45% by mass, even when said hot-pressing is applied at a temperature of over the melting point of said low melting point fibers, said fiber sheet has good releasability. A plural number of said sheets are laminated together.

Said molded porous material of the present invention is useful as a base panel for automobile interiors or exteriors, such as head lining, dash silencer, hood silencer, under engine cover silencer, cylinder head cover silencer, outer dash silencer, floor mat, dash board, door trim, or reinforcement that is laminated onto said base panel, or a sound insulating material, heat insulating material, or building material.

In said press-molding, said resin compound which is coated or impregnated or mixed on/in to said porous material oozes to the surface of said porous material, the resulting oozing layer of resin compound containing said colloidal silica, effectively preventing the occurrence of resinous surface gloss.

Nonwoven fabric(s) may be laminated onto one side or both sides of said porous material of the present invention. Said resin used for said porous material may also be coated, impregnated or mixed for said nonwoven fabric(s). To bond said porous material of the present invention and said nonwoven fabric(s), a hot melt adhesive sheet or hot melt adhesive powder is used, and further in a case where a synthetic resin is coated onto said fiber sheet, said nonwoven fabric(s) may be bonded to said fiber sheet with said synthetic resin.

Said hot melt adhesive sheet or hot melt adhesive powder is made of a synthetic resin having a low melting point, for example, a polyolefin group resin (including modified polyolefin resin) such as polyethylene, polypropylene, ethylene-vinyl acetate copolymer, ethylene-ethyl acrylate copolymer, or the like; polyurethane, polyester, copolymerized polyester, polyamide, copolymerized polyamide or a mixture of two or more kinds of said synthetic resin having a low melting point.

In a case where said hot melt adhesive sheet is used as an adhesive, for example said hot melt adhesive sheet is laminated onto said porous material by extruding said hot melt adhesive sheet from a T-die, after which said nonwoven fabric is laminated onto said porous material, then hot press molded.

For the purpose of ensuring air permeability, said hot melt sheet is preferably porous. To make said hot melt sheet porous, a lot of fine holes are first made on said hot melt sheet, or said hot melt sheet is laminated onto said porous material, and then needle punched, or the like, or a heated and softened hot melt sheet which is extruded from the T-die is laminated onto said porous material, after which the resulting layered material is pressed. The resulting film may become porous, having a lot of fine holes. Said holes in said thermoplastic resin film may be formed by the shag on the surface of said porous material. In this method, no process is necessary to form holes in said film, and fine holes may give the product an improved sound absorption property. In a case where said hot melt adhesive powder is used for adhesion, the resulting molded article's air permeability is ensured.

The ventilation resistance of said molded material manufactured by the molding of said laminated porous material is preferably in the range of between 0.1 and 100 kPa·s/m. Said molded material has an excellent sound absorption property.

EXAMPLES of the present invention are described below. However, the scope of the present invention should not be limited only by said EXAMPLES.

The colloidal silica dispersion used in EXAMPLES is described below.

Nissan Chemical Industries, Ltd.:

Snowtex 20, Snowtex 30, Snowtex 40, Snowtex C, Snowtex N, Snowtex O, Snowtex S, Snowtex20L, Snowtex OL (Trade Name)

Nicca Chemical Co., Ltd.

Primetone FF-1 (Trade Name)

Kyoeisha Chemical Co., Ltd.

CLA-530

Colcoat Co., Ltd.

HAS-10 (Trade Name)

Nihon Chemical Industrial Co., Ltd. Silicadol (Trade Name)

### EXAMPLE

A nonwoven fabric made of a polyester fiber and having a unit weight of 80 g/m², said nonwoven fabric having been manufactured by the needle punching method, was used as a fiber sheet. Mixtures were prepared by mixing a resol type phenol-formaldehyde precondensation polymer (water solution having a solid content of 40% by weight) and Snowtex 40 (Trade Name, Nissan Chemical Industries Ltd. water solution having a concentration of 40% by mass) as a colloidal silica solution at a mass ratio of solid precondensation polymer (as resin)/Snowtex (as SiO²)=95 to 20/5 to 80 as shown in Table 1. After each mixture was impregnated into said fiber sheet, said fiber sheet was squeezed with a mangle roll to adjust the amount of said mixture impregnated into said fiber sheet to be 40% by mass. The resulting fiber sheet into which said mixture was impregnated was then dried at 120° C. for 4 minutes to precure said precondensation polymer. The resulting fiber sheet into which said precured precondensation polymer was impregnated was used as a surface material and a foamed melamine resin sheet (thickness: 20 mm, density: 8.5 kg/m³) was used as a base material, and then said surface material and said base material were lapped together to form a laminated sheet, and the resulting laminated sheet was hot-pressed at 200° C. for 60 seconds, to obtain two kinds of molded porous material, each molded porous material having a thickness of t=10 mm or 5 mm.

[Comparison]

Two kinds of molded porous material, having a thickness of t=10 mm or 5 mm were manufactured by hot-pressing in the same manner as in EXAMPLE 1, with the exception that the mass ratio of the mixture of solid precondensation (as resin)/Snowtex (as SiO₂) was 97/3.

Test results are shown in Table 1

TABLE 1

| | | EXAMPLE 1 | | | | | | COMPARISON 1 |
|---|---|---|---|---|---|---|---|---|
| Sample No. | | 1 | 2 | 3 | 4 | 5 | 6 | 7 |
| Mass | Precondensation | 95 | 80 | 60 | 50 | 40 | 20 | 97 |
| ratio | polymer | | | | | | | |
| | Snowtex 40 | 5 | 20 | 40 | 50 | 60 | 80 | 3 |

| | | | | | | | | |
|---|---|---|---|---|---|---|---|---|
| Resinous | t = 5 | Δ | ◯ | ◯ | ⊚ | ⊚ | ⊚ | X X |
| surface | t = 10 | ◯ | ⊚ | ⊚ | ⊚ | ⊚ | ⊚ | X |
| gloss*¹ | | | | | | | | |

Test method and judgement criterion
*¹Resinous surface gloss
The appearance of the surface of the resulting molded porous material was observed to check the condition of the formed dotted or striped semitransparent film.
⊚: A beautiful surface without visible defect
◯: Parts having resinous surface gloss were observed slightly on the surface.
Δ: Resinous surface gloss was observed on 5 to 10% of the whole surface.
X: Resinous surface gloss was clearly observed on 50 to 70% of the whole surface.
X X: Resinous surface gloss was clearly observed on the whole surface.

Referring to Table 1, it is recognized that in a case where the resulting molded porous material is not thick enough, the face pressure on the surface of said laminated sheet is too excessive when said laminated sheet is being molded, resulting in a stronger occurrence of resinous surface gloss. Further, referring to Comparison 1 (sample No. 7), in a case where the amount of colloidal silica added to said precondensation polymer is insufficient, the likelihood of the occurrence of said resinous surface gloss increases, degrading the appearance of the resulting molded porous material. Further, referring to samples No.4 to No.6 of EXAMPLE 1, in a case where said colloidal silica is added to said precondensation polymer in an amount of more than 50 by mass ratio, no change in the occurrence of the resinous surface gloss is recognized

### Example 2

A non woven fabric made of a polyester fiber and having a unit weight of 800g/m2 and a thickness of 15 mm, said nonwoven fabric having been manufactured by the needle punching method, was used as a fiber sheet. Said mixture used in EXAMPLE 1 was impregnated into said fiber sheet, after which said fiber sheet was then squeezed with a mangle roll to adjust the amount of said mixture impregnated into said fiber sheet to be 60% by mass. The resulting fiber sheet into which said mixture was impregnated was then suction dried at 120° C. for 8 minutes to precure said precondensation polymer in said fiber sheet. The resulting fiber sheet into which said precured precondensation polymer was impregnated, was then hot-pressed at 210° C. for 60 seconds, to obtain two kinds of molded porous material, each molded porous material having a thickness of t=10 mm or 5 mm.

[Comparison 2]

Two kinds of molded porous material, having thickness of t=10 mm or 5 mm, were manufactured by hot-pressing in the same manner as in EXAMPLE 2, with the exception that the mixture in COMPARISON 1 was used.

Test results are shown in Table 2.

TABLE 2

| | | EXAMPLE 2 | | | | | | COMPARISON 2 |
|---|---|---|---|---|---|---|---|---|
| Sample No. | | 8 | 9 | 10 | 11 | 12 | 13 | 14 |
| Mass | Precondensation | 95 | 80 | 60 | 50 | 40 | 20 | 97 |
| ratio | polymer | | | | | | | |
| | Snowtex 40 | 5 | 20 | 40 | 50 | 60 | 80 | 3 |

| | | | | | | | | |
|---|---|---|---|---|---|---|---|---|
| Resinous | t = 5 | Δ | Δ | ◯ | ⊚ | ⊚ | ⊚ | X X |
| surface | t = 10 | ◯ | ◯ | ⊚ | ⊚ | ⊚ | ⊚ | X X |
| gloss*² | | | | | | | | |
| Rigidity*³ | t = 5 | ⊚ | ⊚ | ⊚ | ⊚ | ◯ | Δ | ⊚ |
| | t = 10 | ⊚ | ⊚ | ⊚ | ⊚ | ◯ | X | ⊚ |

Test method and judgement criterion
*²Resinous surface gloss
The appearance of the surface of the resulting molded porous material was observed to check the condition of the formed dotted or striped semitransparent film.
Judgement criterion is the same as in Table 1.
*³Rigidity
The rigidity of the molded porous material when being handled by hand was checked.
⊚: Easily handled without forming wrinkles or bending.
◯: It is possible to form wrinkles when the molded porous material is handled by its corners.
Δ: It is possible that the molded porous material can be snapped with little force, and has a problem to handle.
X: Wrinkle and snapping are caused in the molded porous material during handling, damaging its workability.

Referring to the results of COMPARISON 2 (Sample No. 14) in Table 2, it is recognized that in a case where the amount of said colloidal silica added to said precondensation polymer is insufficient, the occurrence of resinous surface gloss tends to increase. Further, referring to sample No.14 in EXAMPLE 2. in a case where the amount of said colloidal silica added to said precondensation polymer is excessive, as a result, it won't affect the surface appearance of said molded porous material, but will degrade the strength of said molded porous material.

### Example 3

A nonwoven fabric made of a polyester fiber and having a unit weight of 80 g/m², said nonwoven fabric having been manufactured by the needle punching method, was used as a fiber sheet. A mixture was prepared by mixing 40 parts by mass of a sulfomethylated phenol-alkylresorcinol-formaldehyde precondensation polymer (water solution having a solid content of 45% by mass), 1 part by mass of a carbon black dispersion (water dispersion having a solid content of 30% by mass), 2 parts by mass of a fluorine group water and oil repellent agent (water dispersion having a solid content of 40% by mass), 5 parts by mass of a flame retardant containing nitrogen and phosphorous, 0.5 parts by mass of a wax group internal release agent (water dispersion having a solid content of 40% by mass), 20 parts by mass of Snowtex 20 (Trade Name. Nissan Chemical Industries Ltd., 20% by mass of a water solution as an SiO₂ concentration), and 31.5 parts by mass of water. Said mixture was then coated and impregnated on/in to said fiber sheet by roll coating, the amount of said mixture to be coated onto said fiber sheet being adjusted to be 30% by mass, and further, a polyamide powder (particle size: 400˜500 μm, melting point: 130° C.) as a hot melt adhesive was scattered on the back side of said fiber sheet. The resulting fiber sheet was then dried at 140° C. for 3 minutes to precure said precondensation polymer in said fiber sheet, and at the same time to melt said hot melt adhesive so as to fix it onto said fiber sheet, to obtain a fiber sheet having flame retardancy. Said flame retardant fiber sheet was then used as a surface material and a foamed melamine resin having a thickness of 20 mm, and a density of 8.5 kg/m³ was used as a flame retardant base material. Said fiber sheet was lapped onto said base material so as to contact the back side of said fiber sheet to said base material, following which the resulting laminated sheet was then hot-pressed at 200° C. for 60 seconds, to obtain a molded porous material having a predetermined shape. The resulting molded porous material had excellent rigidity, and no resinous surface gloss occurrence was recognized on the compressed parts having a thickness of t=2 to 3 mm at either end of said molded porous material. Said porous material had no visible defects, had excellent flame retardancy, and is useful as an engine hood silencer and a dash outer silencer.

[Comparison 3]

In EXAMPLE 3, a molded porous material was obtained in the same manner, with the exception that water was used instead of Snowtex. The resulting molded porous material had good rigidity, but resinous surface gloss occurred on the entire surface of said molded porous material, especially at either end, both of which were compressed to a thickness of t=2-3 mm, and both of which had remarkable resinous surface gloss, resulting in said molded porous material having a defective appearance.

### Example 4

A nonwoven fabric made of a polyester fiber and having a unit weight of 50 g/m2, said nonwoven fabric having been manufactured by the needle punching method, was used as a fiber sheet. A mixture was prepared by mixing 40 parts by mass of a sulfimethylated phenol-alkyl resorcinol-formaldehyde precondensation polymer (water solution having a solid content of 45% by mass), 1 part by mass of a carbon black dispersion (water dispersion having a solid content of 30% by mass), 2 parts by mass of a fluorine group water and oil repellent agent (water dispersion having a solid content of 25% by mass), 5 parts by mass of a flame retardant containing nitrogen and phosphorous (water dispersion having a solid content of 40% by mass), 30 parts by mass of Snowtex C (Trade name, Nissan Chemical Industries Ltd., 20% by mass of a water solution as an SiO₂ concentration), and 22 parts by mass of water. The resulting mixture was then coated and impregnated on/in to said fiber sheet by roll coating, the amount of said mixture to be coated onto said fiber sheet being adjusted to be 20% by mass, and the resulting fiber sheet into which said mixture was impregnated was then dried at 140° C. for 2 minutes to precure said precondensation polymer in said fiber sheet, so as to obtain a precured flame retardant fiber sheet. The resulting precured fiber sheet was used as a surface material, and using as a flame retardant base material, an uncured flame retardant felt source (thickness: 20 mm, unit weight: 1000 g/m²) consisting of a reclaimed fiber, in which 20% by mass of ammonium polyphosphate powder, and 25% by mass of a novolak type phenol resin powder with a curing agent were mixed, and said flame retardant fiber sheet and said uncured felt source were lapped together so as to contact the back side of said fiber sheet to said uncured felt source, and the resulting laminated sheet was then hot-pressed at 200° C. for 60 seconds, to obtain a molded porous material having a predetermined shape. The resulting molded porous material had excellent rigidity and no occurrence of resinous surface gloss from the oozing of resin, and no problems with the appearance of said surface material, and said molded porous material had excellent flame retardancy, being usable for an engine hood silencer, dash outer silencer, cylinder head cover silencer, engine under cover silencer, and the like, of an automobile.

### Example 5

A nonwoven fabric made of a polyester-rayon fiber mixture and manufactured by the chemical bonding method (thickness: 1.0 mm unit weight: 150 g/m²) was used as a fiber sheet. A mixture was prepared by mixing 20 parts by mass of a methylated trimethylol melamine resin (water solution having a solid content of 60% by mass), 1 part by mass of a flouorine group water and oil repellent agent (water solution having a solid content of 25% by mass), 3 parts by mass of a flame retardant containing nitrogen and phosphorous (water dispersion having a solid content of 40% by mass), 30 parts by mass of Snowtex N (Trade Name, Nissan Chemical Industries Ltd.: 20% by mass of a water solution as an SiO₂ concentration), 44.6 parts by mass of water, and 1.4 parts by mass of an organic amine group curing agent. The resulting mixture was then coated and impregnated on/in to said fiber sheet by roll coating, the amount of said mixture to be coated onto said fiber sheet being adjusted to be 10% by mass, after which the resulting fiber sheet into which said mixture was impregnated was then dried at 110° C. for 2 minutes, to obtain a flame retardant fiber sheet. The resulting fiber sheet was used as a surface material, and using a flame retardant glass wool source (thickness 50 mm: unit weight: 600 g/m²) containing a resol type phenol resin as a base, said flame retardant fiber sheet and said glass wool source was lapped together, and between them a foamed polyurethane having a thickness of 5 mm on both sides of which methylenediisocyanate was coated in a coating amount of 10 g/m₂, was put as a cushion layer. The resulting laminated sheet was then hot pressed at 200° C. for 50 seconds, to obtain a molded porous material having a predetermined shape. The resulting molded porous material had no resinous surface gloss occurrence, and an excellent appearance.

### Example 6

A non woven fabric made of a polyester fiber by the needle punching method, and having a unit weight of 70 g/m² was used as a fiber sheet. A mixture was prepared by mixing 40 parts by mass of a phenol-resorcinol-formaldehyde precondensation polymer, (water solution having a solid content of 45% by mass), 1 part by mass of a carbon black dispersion (water dispersion having a solid content of 30% by mass), 2 parts by mass of a fluorine group water and oil repellent agent (water solution having a solid content of 25% by mass), 5 parts by mass of a flame retardant containing nitrogen and phosphorous, 20 parts by mass of Snowtex S (Trade Name: Nissan Chemical Industries Ltd., 30% by mass of a water solution as an SiO₂ concentration), and 32 parts by mass of water. The resulting mixture was then coated and impregnated on/in to said fiber sheet by roll coating, the amount to be coated onto said fiber sheet being adjusted to be 25% by mass, and further a mixture consisting of 5 parts of a polyamide powder (particle size: 40 to 50 μm, melting point: 130° C.) as a hot melt adhesive, 20 parts by mass of a ammonium polyphosphate powder (particle size 30 to 40 μm), 15 parts by mass of an acrylic resin emulsion (solid content 50% by mass) and 60 parts by mass of water was prepared, and the resulting mixture was then spray coated onto the back side of said fiber sheet, the amount to be coated being adjusted to be 100 g/m² (wet), after which said fiber sheet was precured at 140° C. for 4 minutes, to obtain a flame retardant precured fiber sheet. Using said flame retardant precured fiber sheet as a surface material, and a foamed melamine resin (thickness 20 mm, density: 9.1 kg/m³) as a flame retardant base material, said flame retardant fiber sheet and said base material were lapped together so as to contact the back side of said flame retardant fiber sheet to said foamed melamine resin, and the resulting laminated sheet was then hot-pressed at 200° C. for 60 seconds, to obtain a molded material having a prescribed shape. The resulting molded porous material had excellent rigidity and no resinous surface gloss occurrence on the surface of said surface material even at the compressed parts having a thickness of 2 to 3 mm, and said molded porous material had an excellent appearance, flame retardancy, and sound absorbing property, and is useful as an engine hood silencer and dash outer silencer, both of which are used in automobiles.

[Comparison 4]

In EXAMPLE 6, a molded porous material was manufactured in the same manner, with the exception that water was used in said mixture instead of Snowtex S, and the resulting molded porous material had a good rigidity, sound absorbing property and flame retardancy, but resinous surface gloss was observed on the surface of said surface material, and especially heavy resinous surface gloss occurred at the compressed parts having thickness of 2-3 mm, onto which substantial face pressure was effected during press-molding, resulting in an inferior appearance and impression.

### Example 7

A non woven fabric made of a polyester and by the needle punching method and having a unit weight of 120 g/m² was used as a fiber sheet. A mixture was prepared by mixing 40 parts by mass of a phenol-formaldehyde precondensation polymer (water solution having a solid content of 45% by mass), 1 part by mass of a carbon black dispersion (water dispersion having a solid content of 30% by mass), 2 parts by mass of a release agent for the internal addition made of a surfactant (water solution having a solid content of 30% by mass), 5 parts by mass of Snowtex (Trade name, Nissan Chemical Industries Ltd. 40% by mass of a water solution as an SiO₂ concentration) and 52 parts by mass of water. The resulting mixture was then coated and impregnated on/in to said fiber sheet by roll coating, the amount to be coated being adjusted to be 25% by mass, following which the resulting fiber sheet into which said mixture was impregnated, was then dried at 130° C. for 3 minutes to precure. Said precured fiber sheet was then used as a surface material, and a glass wool source to which a resol type phenol resin was added (thickness:50mm, unit weight, 600 g/m²) was used as a base material. Said surface material and said base material were lapped together, and the resulting laminated sheet was then molded by hot-pressing at 200° C. for 60 seconds, after which the resulting molded material was trimmed. Test results from the resulting trimmed molded material are shown in Table 3.

### Example 8

A trimmed molded material was manufactured in the same manner as in EXAMPLE 7, with the exception that 54 parts by mass of water was used instead of said release agent for the internal addition made of a surfactant. The test results from the resulting trimmed molded material are shown in Table 3.

[Comparison 5]

A trimmed molded material was manufactured in the same manner as in EXAMPLE 7, with the exception that 57 parts by mass of water was used instead of Snowtex 40. The test results from the resulting trimmed molded material are shown in Table 3.

[Comparison 6]

A trimmed molded material was manufactured in the same manner as in EXAMPLE 7, with the exception that 59 parts by mass of water was added instead of Snowtex 40 and said release agent for the internal addition, and the test results from the resulting trimmed molded material are shown in Table 3.

TABLE 3

| | EXAMPLE 7 | EXAMPLE 8 | COMPARISON 5 | COMPARISON 6 |
|---|---|---|---|---|
| Resinous surface gloss *⁴ | ◯ | ◯ | X | X |
| Demolding*⁵ | ⊚ | ◯ | ◯ | Δ |
| Trimming workability*⁶ | ◯ | ◯ | Δ | X |

Test method and judgement criterion
*⁴Resinous surface gloss
The appearance of the surface of the resulting molded porous material was observed to check the condition of the formed dotted and striped semitransparent film.
Judgement criterion is the same as in Table 1.
*⁵Demolding
The ease of demolding after hot pressing at 200° C for 60 seconds was checked
⊚: Excellent demolding workability and only one coating of the release agent on the mold for 40 times of continuous molding guarantees enough demolding workability.
◯: Good demolding workability and one coating of the release agent on the mold for 30 times of continuous molding guarantees enough demolding workability.
Δ: The resulting molded material was apt to stick to the mold, one coating of the release agent on the mold for 3 times of continuous molding being necessary.
*⁶Trimming workability
After said molded material was cooled, it was then trimmed by punching it into a predetermined shape. After this the condition of the trimmed face was checked.
◯: Excellent trimming workability, trimming was performed exactly to obtain wall-shaped trimmed face.
Δ: Trimmed face was not sharp, with partially loose nonwoven fabric fibers observed.
X: Striped fibers from the loose nonwoven fabric were observed around the trimmed parts.

Considering the results of EXAMPLE 8 and COMPARISON 5, in a case where colloidal silica is added to the resin, almost the same demolding workability as in the addition of a conventional internal release agent is demonstrated. Further, by adding colloidal silica, it is recognized that sharp trimmed face is obtained when said molded porous material is trimmed. It seems that these effects are caused by an improvement in the binding of fibers, their hardness and rigidity.

Possibility of the Industrial Use

Since the molded porous material of the present invention has no problem in the occurrence of resinous gloss on its surface, said molded porous material has excellent appearance, making it useful for automobile or building interiors or exteriors.

1. (canceled)

2. (cancelled)

3. A method for manufacturing a molded porous material comprising: preparing a resin compound for processing a porous material made of a thermosetting resin precursor into which a colloidal silica is mixed in an amount of more than 5% by mass for said thermosetting resin precursor, coating, impregnating or mixing said resin compound on/in to a porous material, and press-molding said porous material on/in to which said resin compound is coated, impregnated or mixed.

4. A method for manufacturing a molded porous material in accordance with claim 3, wherein said porous material is a fiber sheet.
